(19) United States
(12) Patent Application Publication
(10) Pub. No.: US 2024/0217856 A1
(43) Pub. Date: Jul. 4, 2024

(54) METHOD FOR PREPARING SLUDGE CONDITIONER FROM WATER SUPPLY SLUDGE AND USE OF SLUDGE CONDITIONER

(71) Applicants: Tongji University, Shanghai (CN); China Three Gorges Corporation, Hubei (CN); Three Gorges Environmental Technology Co., LTD, Shanghai (CN)

(72) Inventors: Bin DONG, Shanghai (CN); Tingting XIAO, Shanghai (CN); Zuxin XU, Shanghai (CN); Haibin WU, Shanghai (CN); Dianchang WANG, Shanghai (CN); Chong LI, Shanghai (CN); Danni SHEN, Shanghai (CN); Xiankai WANG, Shanghai (CN); Feng LIU, Shanghai (CN); Sisi CHEN, Shanghai (CN)

(21) Appl. No.: 17/998,434

(22) PCT Filed: Jul. 27, 2022
(86) PCT No.: PCT/CN2022/108161

§ 371 Date: Nov. 10, 2022

(30) Foreign Application Priority Data
Nov. 5, 2022 (CN) 202111304440.2

(51) Int. Cl. C02F 11/143; C02F 11/00; C02F 11/06; C02F 11/121; C02F 11/13

(52) U.S. Cl. CPC C02F 11/143; C02F 11/008; C02F 11/06; C02F 11/121; C02F 11/13; C02F 2209/02; C02F 2209/06; C02F 2303/06; C02F 2305/023; C02F 2305/026

(57) ABSTRACT

The present disclosure discloses a method for preparing a sludge conditioner from water supply sludge and a use of the sludge conditioner. The sludge conditioner is prepared by mixing the water supply sludge and sewage sludge. The method includes the following steps: mixing the water supply sludge and the sewage sludge in proportion, adding a pore forming agent, stirring a mixture uniformly, and conducting mechanical dehydration, air-drying, grinding, sieving, and pyrolysis to obtain the sludge conditioner. The conditioner is used in advanced oxidation technologies such as catalyzed/activated ozone oxidation, persulfate oxidation, and Fenton oxidation to condition the sludge and enhance dehydration performance. The sludge carbon-based conditioner with efficient catalytic performance and adsorption performance is prepared from the sludge of a water supply plant and a sewage plant, and a chemical conditioning technology of advanced oxidation is coupled for improving the dehydration performance of sludge and adsorbing heavy metals.

### CROSS REFERENCE TO RELATED APPLICATION

This application claims the priority of Chinese Patent Application CN202111304440.2, entitled “METHOD FOR PREPARING SLUDGE CONDITIONER FROM WATER SUPPLY SLUDGE AND USE OF SLUDGE CONDITIONER”, and filed with China National Intellectual Property Administration (CNIPA) on Nov. 5, 2021, which is incorporated herein by reference in its entirety.

### TECHNICAL FIELD

The present disclosure relates to the field of sludge treatment and disposal and resource utilization, and in particular, to a method for preparing a sludge conditioner from water supply sludge and a use of the sludge conditioner.

### BACKGROUND ART

The sources of sludge mainly include municipal sewage plants, water supply and purification plants, industrial water plants, and river and lake sediments. The urban sludge accounts for a relatively large proportion, which is mainly composed of sewage sludge and water supply sludge. The sewage sludge, produced from the activated sludge process for water treatment, has the characteristics of high water content, difficult dehydration, easy decay, and heavy odor, and also contains a large number of extracellular polymers, pathogenic bacteria, and heavy metals that are difficult to degrade. The water supply sludge is a large amount of sludge rich in iron or aluminum salts produced from the addition of coagulants or flocculants to drinking water sources to remove turbidity, color, pathogens, and natural organic matters. Different from the sewage sludge, the water supply sludge has a low organic matter content and a high silica content, so that it is unsuitable for biodegradation and incineration treatment methods, and due to high concentrations of metals, it is also unsuitable for terrestrial applications. Due to the high content of bound water, it is also difficult to dehydrate the water supply sludge. Therefore, as a key link in sludge treatment, dehydration can minimize the amount of sludge, facilitate transportation, and reduce the cost of treatment and disposal. It is an effective way to avoid secondary pollution by recycling the dehydrated sludge, which has become the focus of environmental pollution prevention and control. The sewage sludge and the water supply sludge are often treated and disposed separately. With the deepening understanding of the characteristics of the two types of sludge and the establishment and improvement of the integrated water supply and drainage system, the research and application of the combined treatment and disposal of sludge from two types of water plants is worth considering.

The water supply sludge mainly contains inorganic components such as SiO₂, Fe₂O₃, Al₂O₃, and CaCO; and a small amount of organic components, which has certain hardness, and has a certain porosity and a large specific surface area after dehydration, showing excellent catalytic performance and adsorption performance. Combining the characteristics of the water supply sludge, it is an important demand for sludge recycling to modify the water supply sludge and reuse it scientifically. The application of the water supply sludge generally depends on its physicochemical properties and available application conditions. At present, the water supply sludge is mainly used as an adsorbent for phosphorus (P) and other pollutants in sewage, and as a substitute for the manufacture of ceramsite or building materials. For example, the patent CN106540650A discloses a method for preparing a water supply plant sludge-based phosphorus removal particle adsorbent. The patent CN105903426A discloses modified water supply sludge and a preparation method and use thereof, which is used as an ammonia nitrogen adsorbent. The patent CN103723999A discloses a method for preparing flower ceramsite from urban water supply sludge. However, there is no report on sludge conditioning by mixing water supply sludge and sewage sludge to prepare a sludge-based conditioner.

The water supply sludge contains a large amount of residual Fe₂O₃, Al₂O₃, and inorganic particulate matters, which can be used as chemical and physical regulators respectively. Therefore, adding the water supply sludge to improve the dehydration capacity of sludge is a feasible and environment-friendly conditioning process. The water supply sludge can be used as a physical modifier to form a permeable and more rigid lattice structure due to its hardness, so as to maintain the porosity under high pressure during mechanical dehydration. Adding it directly to the excess sludge may lead to the dissolution of organic matters in the water supply sludge, which is not conducive to dehydration. It can be considered that after thermal modification, moisture and volatile components escape, and a large number of pores appear after carbonization of organic matters, forming a skeleton structure, which can be used as a framework material and an adsorbent for heavy metals (As, Cd, Cr, Cu, Ni, Pb, and Zn) and organic pollutants.

### SUMMARY

An objective of the present disclosure is to overcome the problems existing in the above-mentioned prior art, and to provide a method for preparing a sludge conditioner from water supply sludge and a use of the sludge conditioner. First, the problem of insufficient utilization of water supply sludge containing a large amount of iron/aluminum salt coagulant components is solved, and the environmental problem of multi-source sludge conditioning with the goal of enhancing dehydration performance and adsorbing heavy metals is solved.

To achieve the above objectives, the present disclosure is achieved by the following technical solution:

A method for preparing a sludge conditioner from water supply sludge is provided. The conditioner is prepared by mixing the water supply sludge and sewage sludge. The method specifically includes the following steps: mixing the water supply sludge and the sewage sludge in proportion, adding a pore forming agent, stirring a mixture uniformly, and conducting mechanical dehydration, air-drying, grinding, sieving and pyrolysis to obtain the sludge conditioner.

Preferably, the sewage sludge may have a water content of 92-95 wt. %.

The sewage sludge may have a water content of 92-95 wt. %, and a carbon content in a range of 15-30 mg/g dry basis. The water supply sludge may have a water content of 60-80 wt. %, and an iron/aluminum salt content in a range of 50-250 mg/g dry basis.

Preferably, the water supply sludge and the sewage sludge may have a mixing ratio of 1:3 to 5:1, and the mixing ratio may be calculated according to a ratio of a sludge dry basis.

Preferably, the pore forming agent may be one or more selected from the group consisting of an acid, alkali, or inorganic salt that does not react with a matrix, for example, one or more selected from the group consisting of phosphoric acid, sodium hydroxide, Na₂SO₄, NaCl, and CaCl₂). The pore forming agent may have a dosage of 0.5-2 mmol/g dry basis.

Preferably, a drying method for the mixed sludge may be natural air-drying or drying at 30-60° C., and after grinding, sieving may be conducted through a 40-80 mesh sieve.

Preferably, the pyrolysis of the mixed sludge may be achieved through segmented calcination with a tube furnace. The calcination may be conducted under an inert atmosphere with nitrogen or argon as a carrier gas at a gas flow rate of 80-260 mL/min. The low-temperature section calcination may start a pyrolysis program from a room temperature at a heating rate of 5-10° C./min for the pyrolysis at 100-260° C. for a pyrolysis residence time of 30-40 min. The medium-temperature section calcination may be conducted at a heating rate of 15-30° C./min for the pyrolysis at 260-600° C. for a pyrolysis residence time of 20-50 min. The high-temperature section calcination may be conducted at a heating rate of 30-60° C./min for the pyrolysis at 600-960° C. for a pyrolysis residence time of 40-90 min. Cooling may be conducted at 10-20° C./min after the pyrolysis.

The inventor finds that there are many factors affecting the catalytic performance and adsorption performance of the conditioner in the pyrolysis preparation process. In order to ensure that the prepared conditioner has a larger specific surface area, a pore structure, and abundant surface functional groups, preferably, the pyrolysis method is segmented pyrolysis, which is divided into a low-temperature section, a medium-temperature section, and a high-temperature section.

The above sludge conditioner is used in catalytic/activated ozone oxidation, persulfate oxidation, and Fenton/Fenton-like oxidation. The target sludge is adjusted to an applicable pH range, and the prepared sludge conditioner is added, so as to enhance dehydration performance of the target sludge and adsorb heavy metals and other organic pollutants in the sludge, and reduce the pollution of dehydrated filtrate.

Preferably, the sludge to be conditioned may be any one of municipal sewage sludge, industrial sewage sludge, or river and lake sediments, and may have a water content of 90-99 wt. %.

Preferably, the sludge to be conditioned may be conditioned to an applicable pH range of 2-9.

Preferably, the conditioner may have a dosage of 50-600 mg/g dry basis.

The inventor finds that the sludge to be conditioned by the ozone oxidation conditioning technology has an applicable pH range of 3-5, and ozone has a dosage in a range of 20-100 mg/g dry basis. The sludge to be conditioned by the persulfate oxidation conditioning technology has an applicable pH range of 4-9, and persulfate has a dosage in a range of 0.5-1.8 mmol/g dry basis. The sludge to be conditioned by the Fenton/Fenton-like conditioning technology has an applicable pH range of 2-4, and hydrogen peroxide has a dosage in a range of 30-90 mg/g dry basis.

Preferably, the conditioned target sludge may be recycled to prepare the sludge conditioner.

The working principle of the present disclosure is as follows: a conditioner with a large specific surface area, a pore structure, and abundant surface functional groups is prepared through segmented pyrolysis of a large amount of iron/aluminum salt components remaining in the water supply sludge by using sewage sludge as a carbon-based material. Its surface properties increase the catalytic activity and adsorption active sites, and it can effectively destroy the sludge floc structure when used in the advanced oxidation technology for chemical conditioning of sludge. The oxidized hydrophilic extracellular polymer is degraded into a soluble organic matter, which increases the fluidity of intracellular bound water and improves the dehydration performance of the sludge. With the disintegration of the sludge flocs, the heavy metals and other organic pollutants enriched in the flocs are released. The conditioner can achieve effective adsorption of heavy metals and other organic pollutants by using its adsorption characteristics, and achieve sludge reduction and filtrate pollution blocking.

Compared with the prior art, the present disclosure has the following advantages:
(1) The present disclosure prepares the sludge conditioner by using the water supply sludge and the sewage sludge together, which is a new material preparation technology with high added value, and provides a new idea for sludge resource recycling.
(2) Compared with the sludge-based materials prepared by separate pyrolysis of the water supply sludge or the sewage sludge, the conditioner prepared by the present disclosure has the advantages of larger specific surface area, enhanced pore structure, and significantly improved catalytic performance and adsorption performance.
(3) The sludge conditioner prepared by using the water supply sludge and the sewage sludge together is used for sludge conditioning, which reduces the pollution of dehydrated filtrate when the sludge is efficiently dehydrated, and improves the application value of sludge engineering.

### BRIEF DESCRIPTION OF THE DRAWINGS

FIG. 1 is a scanning electron microscope (SEM) image of the sludge conditioner obtained in Example 1 of the present disclosure;

FIG. 2 is a SEM image of the sludge conditioner obtained in Example 2 of the present disclosure; and

FIG. 3 is a SEM image of the sludge conditioner obtained in Example 3 of the present disclosure.

### DETAILED DESCRIPTION OF THE EMBODIMENTS

The present disclosure will be described in detail below with reference to the drawings and specific examples.

### Example 1

A method for preparing a sludge conditioner from water supply sludge provided by the present disclosure is specifically implemented as follows.

### (1) Preparation of Conditioner

Sewage sludge with a water content of 95 wt. % and water supply sludge with a water content of 75 wt. % were mixed at a dry basis content ratio of 1:1. Then, 0.5 mmol/g dry basis of a pore forming agent, phosphoric acid, was added. A mixture was stirred uniformly. Mechanical dehydration, natural air-drying, and grinding were conducted, and sieving was conducted through a 40 mesh sieve. In a tube furnace, taking nitrogen as a carrier gas, at a gas flow rate of 100 mL/min, in a low-temperature section, a pyrolysis program was started from a room temperature at a heating rate of 5° C./min for the pyrolysis at 120° ° C. for a pyrolysis residence time of 30 min. In a medium-temperature section, at a heating rate of 15° C./min, pyrolysis was achieved at 300° ° C. for a pyrolysis residence time of 30 min. In a high-temperature section, at a heating rate of 30° C./min, pyrolysis was achieved at 600° C. for a pyrolysis residence time of 40 min. Cooling was conducted at 10° C./min after the pyrolysis, and the sludge-based conditioner was collected at a room temperature.

### (2) Target Sludge Conditioning

The sewage sludge with a water content of 97 wt. % was selected as the sludge to be conditioned. Using the catalytic ozone oxidation technology for sludge conditioning, the sewage sludge to be conditioned was adjusted to a pH of 4. 400 mg/g dry basis of the sludge-based conditioner was added. A mixture was stirred and mixed uniformly at 800 rpm, and poured into a sludge conditioning device. Ozone with a dosage of 60 mg/g dry basis was introduced for conditioning for 15 min. After conditioning, the dehydration performance indicators of the sludge and changes in the content of heavy metals in the sludge system were measured: the capillary suction time (CST), the specific resistance to filtration (SRF), and the water content of mud cake (referring to the measured water content of mud cake produced by SRF suction filtration, and the suction filtration pressure was 0.07 MPa). Compared with the sewage sludge before conditioning, the reduction rate of CST was 81.7%, the reduction rate of SRF was 84.6%, and the water content of mud cake was 70.1%. The dehydration performance of the sludge was significantly improved, and the content of heavy metals (As, Cd, Cr, Cu, Ni, Pb, and Zn) in the dehydrated filtrate was significantly reduced by 23.3-67.1%.

### Example 2

A use of preparation of a sludge conditioner from water supply sludge provided by the present disclosure is specifically implemented as follows.

### (1) Preparation of Conditioner

Sewage sludge with a water content of 90 wt. % and water supply sludge with a water content of 70 wt. % were mixed at a dry basis content ratio of 2:1. Then, 1 mmol/g dry basis of a pore forming agent, sodium hydroxide, was added. A mixture was stirred uniformly, subjected to mechanical dehydration, and dried at a 30° C. oven. Grinding was conducted, and sieving was conducted through a 60 mesh sieve. In a tube furnace, taking argon as a carrier gas, at a gas flow rate of 150 mL/min, in a low-temperature section, a pyrolysis program was started from a room temperature at a heating rate of 8ºC/min for the pyrolysis at 150° C. for a pyrolysis residence time of 30 min. In a medium-temperature section, at a heating rate of 20° C./min, pyrolysis was achieved at 400° C. for a pyrolysis residence time of 30 min. In a high-temperature section, at a heating rate of 40° C./min, pyrolysis was achieved at 800° C. for a pyrolysis residence time of 60 min. Cooling was conducted at 15° C./min after the pyrolysis, and the sludge-based conditioner was collected at a room temperature.

### (2) Target Sludge Conditioning

The industrial sludge with a water content of 95 wt. % was selected as the sludge to be conditioned. Using the activated persulfate oxidation technology for sludge conditioning, the sewage sludge to be conditioned was adjusted to a pH of 6. 500 mg/g dry basis of the sludge-based conditioner was added. Persulfate with a dosage of 0.6 mmol/g dry basis was introduced and stirred at 800 rpm for 15 min. After still standing for 10 min, the dehydration performance indicators of the sludge and changes in the content of heavy metals in the sludge system were measured: the CST, the SRF, and the water content of mud cake (referring to the measured water content of mud cake produced by SRF suction filtration, and the suction filtration pressure was 0.07 MPa). Compared with the sewage sludge before conditioning, the reduction rate of CST was 85.3%, the reduction rate of SRF was 87.6%, and the water content of mud cake was 69.5%. The dehydration performance of the sludge was significantly improved, and the content of heavy metals (As, Cd, Cr, Cu, Ni, Pb, and Zn) in the dehydrated filtrate was significantly reduced by 31.7-68.1%.

### Example 3

A use of preparation of a sludge conditioner from water supply sludge provided by the present disclosure is specifically implemented as follows.

### (1) Preparation of Conditioner

Sewage sludge with a water content of 94 wt. % and water supply sludge with a water content of 65 wt. % were mixed at a dry basis content ratio of 1:5. Then, 1.5 mmol/g dry basis of a pore forming agent, CaCl₂), was added. A mixture was stirred uniformly, subjected to mechanical dehydration, and dried at a 45° C. oven. Grinding was conducted, and sieving was conducted through a 80 mesh sieve. In a tube furnace, taking nitrogen as a carrier gas, at a gas flow rate of 200 mL/min, in a low-temperature section, a pyrolysis program was started from a room temperature at a heating rate of 10° C./min for the pyrolysis at 180° C. for a pyrolysis residence time of 40 min. In a medium-temperature section, at a heating rate of 30° C./min, pyrolysis was achieved at 450° ° C. for a pyrolysis residence time of 40 min. In a high-temperature section, at a heating rate of 40° C./min, pyrolysis was achieved at 900° C. for a pyrolysis residence time of 80 min. Cooling was conducted at 20° C./min after the pyrolysis, and the sludge-based conditioner was collected at a room temperature.

### (2) Target Sludge Conditioning

The river and lake sediments with a water content of 92 wt. % were selected as the sludge to be conditioned. Using the Fenton-like oxidation technology for sludge conditioning, the sewage sludge to be conditioned was adjusted to a pH of 2. 600 mg/g dry basis of the sludge-based conditioner was added. Hydrogen peroxide with a dosage of 60 mg/g dry basis was introduced and stirred at 800 rpm for 15 min. After still standing for 10 min, the dehydration performance indicators of the sludge and changes in the content of heavy metals in the sludge system were measured: the CST, the SRF, and the water content of mud cake (referring to the measured water content of mud cake produced by SRF suction filtration, and the suction filtration pressure was 0.07 MPa). Compared with the sewage sludge before conditioning, the reduction rate of CST was 88.6%, the reduction rate of SRF was 85.8%, and the water content of mud cake was 68.2%. The dehydration performance of the sludge was significantly improved, and the content of heavy metals (As, Cd, Cr, Cu, Ni, Pb, and Zn) in the dehydrated filtrate was significantly reduced by 28.7-62.4%.

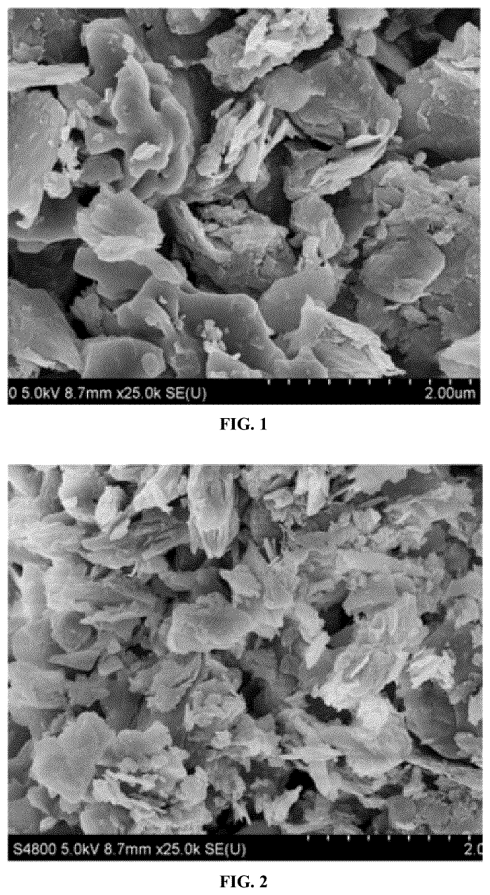

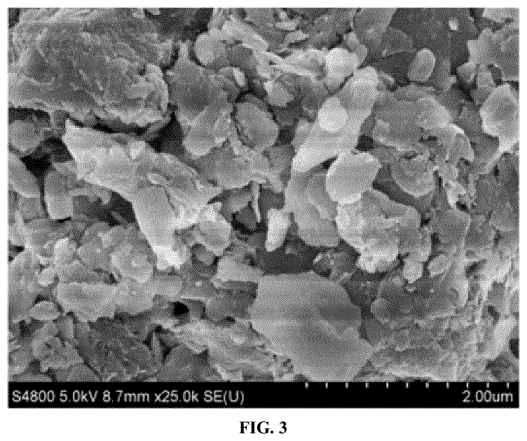

FIG. 1 is a SEM image of a sludge conditioner obtained in Example 1 of the present disclosure. FIG. 2 is a SEM image of a sludge conditioner obtained in Example 2 of the present disclosure. FIG. 3 is a SEM image of a sludge conditioner obtained in Example 3 of the present disclosure. Table 1 shows specific surface area test results of the sludge conditioner obtained in Examples 1 to 3.

TABLE 1
Specific surface area of conditioner obtained in Examples 1 to 3

| Example | S_{BET} (m²/g) |
|---|---|
| Example 1 | 113.87 |
| Example 2 | 108.74 |
| Example 3 | 95.36 |

The above description of the examples is intended to facilitate those of ordinary skill in the art to understand and use the present disclosure. Obviously, those skilled in the art can easily make various modifications to these examples, and apply a general principle described herein to other examples without creative efforts. Therefore, the present disclosure is not limited to the above examples. All improvements and modifications made by those skilled in the art according to the disclosure of the present disclosure with departing from the scope of the present disclosure should fall within the protection scope of the present disclosure.

1. A method for preparing a sludge conditioner from water supply sludge, wherein the sludge conditioner is prepared by mixing the water supply sludge and sewage sludge, and the method comprises the following steps: mixing the water supply sludge and the sewage sludge in proportion, adding a pore forming agent, stirring a mixture uniformly, and conducting mechanical dehydration, drying, grinding, sieving, and pyrolysis to obtain the sludge conditioner.

2. The method according to claim 1, wherein the sewage sludge has a water content of 92-95 wt. %, and a carbon content in a range of 15-30 mg/g dry basis; and the water supply sludge has a water content of 60-80 wt. %, and an iron/aluminum salt content in a range of 50-250 mg/g dry basis.

3. The method according to claim 1, wherein the water supply sludge and the sewage sludge have a mixing ratio of 1:3 to 5:1, and the mixing ratio is calculated according to a ratio of a sludge dry basis.

4. The method according to claim 1, wherein the pore forming agent is one or more selected from the group consisting of an acid, alkali, or inorganic salt that does not react with a matrix.

5. The method according to claim 1, wherein the pore forming agent is one or more selected from the group consisting of phosphoric acid, sodium hydroxide, Na₂SO₄, NaCl, and CaCl₂); and the pore forming agent has a dosage of 0.5-2 mmol/g dry basis.

6. The method according to claim 1, wherein the drying refers to air-drying or drying in an oven at 30-60° C., and after grinding, sieving is conducted through a 40-80 mesh sieve.

7. The method according to claim 1, wherein a method for the pyrolysis is segmented calcination with a tube furnace; and the segmented calcination comprises low-temperature section calcination, medium-temperature section calcination, and high-temperature section calcination conducted sequentially;
the segmented calcination is conducted under an inert atmosphere with nitrogen or argon as a carrier gas at a gas flow rate of 80-260 mL/min; and
the low-temperature section calcination starts a pyrolysis program from a room temperature at a heating rate of 5-10° C./min for the pyrolysis at 100-260° C. for a pyrolysis residence time of 30-40 min; the medium-temperature section calcination is conducted at a heating rate of 15-30° C./min for the pyrolysis at 260-600° ° C. for a pyrolysis residence time of 20-50 min; the high-temperature section calcination is conducted at a heating rate of 30-60° C./min for the pyrolysis at 600-960° C. for a pyrolysis residence time of 40-90 min; and cooling is conducted at 10-20° C./min after the pyrolysis.

8. A sludge conditioner prepared by the method according to claim 1, wherein the sludge conditioner has a porosity of 40-80% and a specific surface area of 60-350 m²/g.

9. A use of the sludge conditioner according to claim 8 in advanced oxidation for chemical conditioning of sludge, wherein the advanced oxidation comprises catalytic/activated ozone oxidation, persulfate oxidation, and Fenton/Fenton-like oxidation, and the use comprises the following steps: adjusting target sludge to an applicable pH range, adding the sludge conditioner for conditioning, and filtering to obtain conditioned sludge and dehydrated filtrate.

10. The use according to claim 9, wherein the target sludge is any one or a combination of municipal sewage sludge, industrial sewage sludge, and river and lake sediments, and has a water content of 90-99 wt. %.

11. The use according to claim 10, wherein the target sludge has an applicable pH range of 2-9; and the sludge conditioner has a dosage of 50-600 mg/g dry basis.

12. The use according to claim 11, wherein when the advanced oxidation is catalytic/activated ozone oxidation, ozone has a dosage of 20-100 mg/g dry basis; and the target sludge has an applicable pH range of 3-5.

13. The use according to claim 11, wherein when the advanced oxidation is persulfate oxidation, persulfate has a dosage of 0.5-1.8 mmol/g dry basis; and the target sludge has an applicable pH range of 4-9.

14. The use according to claim 11, wherein when the advanced oxidation is Fenton/Fenton-like oxidation, an oxidant is hydrogen peroxide; and the hydrogen peroxide has a dosage of 30-90 mg/g dry basis; and the target sludge has an applicable pH range of 2-4.

15. The use according to claim 9, wherein the conditioned sludge is recycled as a raw material for preparing the sludge conditioner.

16. The method of claim 4, wherein the pore forming agent is one or more selected from the group consisting of phosphoric acid, sodium hydroxide, Na₂SO₄, NaCl, and CaCl₂; and the pore forming agent has a dosage of 0.5-2 mmol/g dry basis.

17. The sludge conditioner according to claim 8, wherein the sewage sludge has a water content of 92-95 wt. %, and a carbon content in a range of 15-30 mg/g dry basis; and the water supply sludge has a water content of 60-80 wt. %, and an iron/aluminum salt content in a range of 50-250 mg/g dry basis.

18. The sludge conditioner according to claim 8, wherein the water supply sludge and the sewage sludge have a mixing ratio of 1:3 to 5:1, and the mixing ratio is calculated according to a ratio of a sludge dry basis.

19. The sludge conditioner according to claim 8, wherein the pore forming agent is one or more selected from the group consisting of an acid, alkali, or inorganic salt that does not react with a matrix.

20. The sludge conditioner according to claim 8, wherein the pore forming agent is one or more selected from the group consisting of phosphoric acid, sodium hydroxide, Na₂SO₄, NaCl, and CaCl₂); and the pore forming agent has a dosage of 0.5-2 mmol/g dry basis.
